(19) United States
(12) Patent Application Publication
(10) Pub. No.: US 2021/0129729 A1
(43) Pub. Date: May 6, 2021

(54) METHOD FOR CONTROLLING AN AERIAL UNIT AND A SYSTEM THAT INCLUDES AN AERIAL UNIT

(71) Applicant: SKY Sapience, Yokneam (IL)

(72) Inventors: Shy COHEN, Yokneam Moshava (IL); Zvika Yaniv, Kibutz Megido (IL)

(73) Assignee: SKY Sapience, Yokneam (IL)

(21) Appl. No.: 16/946,676

(22) Filed: Jun. 30, 2020

Related U.S. Application Data
(60) Provisional application No. 62/869,039, filed on Jul. 1, 2019.
(60) Provisional application No. 62/869,115, filed on Jul. 1, 2019.

(51) Int. Cl. B60P 3/11; B64F 1/22

(52) U.S. Cl. CPC B60P 3/11; B64F 1/007; B64F 1/222

(57) ABSTRACT

A vehicle that may include an upper surface, a housing configured to store a drone, the housing having an opening that is formed outside the upper surface; a base that is configured to provide a landing spot to the drone when the base is positioned at least in part outside the housing, and to support the drone when the drone is positioned within the housing; and a base movement unit for moving the base through the opening and between an inside position and an outside position, wherein when the base is positioned in the inside position an area of the base allocated for supporting the drone is located within the housing, wherein when the base is positioned in the outside position the area of the base allocated for supporting the drone is located outside the housing.

### CROSS REFERENCE

This application claims priority of U.S. provisional patents 62/869,039 filing date Jul. 1, 2019 and U.S. provisional patents 62/869,115 filing date Jul. 1, 2019, both incorporated herein by reference.

### BACKGROUND OF THE INVENTION

Various vehicles (including unmanned vehicles) may be relatively compact and have their upper surface fully loaded with payload such as equipment, supplies, and the like.

There may be a need to enhance the capabilities of such vehicles.

### SUMMARY

There may be provided a vehicle that may include (i) an upper surface, (ii) a housing configured to store a drone, the housing having an opening that may be formed outside the upper surface; (iii) a base that may be configured to provide a landing spot to the drone when the base may be positioned at least in part outside the housing, and to support the drone when the drone may be positioned within the housing; and (iv) a base movement unit for moving the base through the opening and between an inside position and an outside position, wherein when the base may be positioned in the inside position an area of the base allocated for supporting the drone may be located within the housing, wherein when the base may be positioned in the outside position the area of the base allocated for supporting the drone may be located outside the housing.

The opening may be a sealed opening.

The opening faces a side of the vehicle.

The opening may be formed below the upper surface.

The opening does not face the upper surface.

The drone may be a tethered drone that may be mechanically coupled, by one or more mechanical coupling elements to the base during a flight of the drone.

The housing may be configured to store the one or more mechanical coupling elements.

The one or more mechanical coupling elements may include a flexible cable that may be mechanically coupled to the drone, a pully for controlling an effective length of the flexible cable, and a gear.

The drone may be an untethered drone.

The base movement unit may be configured to move the base between the inside position and the outside position by performing a linear movement.

The base movement unit may be configured to move the base between the inside position and the outside position by performing a rotational movement.

The housing may be positioned below the upper surface, wherein the upper surface may be a payload support upper surface.

The drone may be a first drone, the base may be a first base, the base movement unit may be a first base movement unit, the housing may be a first housing, wherein the vehicle may include at least the first base, at least the first housing, at least the first base, and the least one base movement unit.

The at least the first housing may be configured to store multiple drones, the multiple drones may include at least the first drone.

The at least one base may include multiple bases, one base for each of the multiple drones.

The at least one base may include multiple bases, one base for two or more drones of the multiple drones.

The vehicle may include a controller for controlling a flight of the drone.

The housing has a width and length that does not exceed one and a half meters.

There may be provided a method for operating a drone, the method may include moving, by a base movement unit, a base that supports a drone between an inside position and an outside position, wherein when the base may be positioned in the inside position an area of the base allocated for supporting the drone and the drone may be located within a housing of a vehicle, wherein when the base may be positioned in the outside position the area of the base allocated for supporting the drone may be located outside the housing, wherein the moving may include moving the drone through an opening of the housing, the housing may be formed outside an upper surface of the vehicle.

The method may include controlling a landing of the drone on the base.

There may be provided an apparatus that comprises a base that may be configured to provide a landing spot to a drone when the base may be positioned at least in part outside a housing of a vehicle, and to support the drone when the drone may be positioned within the housing; and a base movement unit for moving the base through an opening of the housing and between an inside position and an outside position, wherein when the base may be positioned in the inside position an area of the base allocated for supporting the drone may be located within the housing, wherein when the base may be positioned in the outside position the area of the base allocated for supporting the drone may be located outside the housing.

The apparatus may comprise the housing.

### BRIEF DESCRIPTION OF THE DRAWINGS

Further features and advantages of the invention will be apparent from the description below. The invention is herein described, by way of example only, with reference to the accompanying drawings, wherein:

FIG. 1 is an example of a system;

FIG. 2 is an example of a system;

FIG. 3 is an example of a system;

FIG. 4 illustrates various examples of a movement of an aerial unit between close and open position;

FIG. 5 is an example of a system;

FIG. 6 is an example of a system;

FIG. 7 is an example of a system;

FIG. 8 is an example of a system;

FIG. 9 is an example of a system;

FIG. 10 is an example of a system;

FIG. 11 is an example of a system;

FIG. 12 is an example of a housing and covers; and

FIG. 13 is an example of a method.

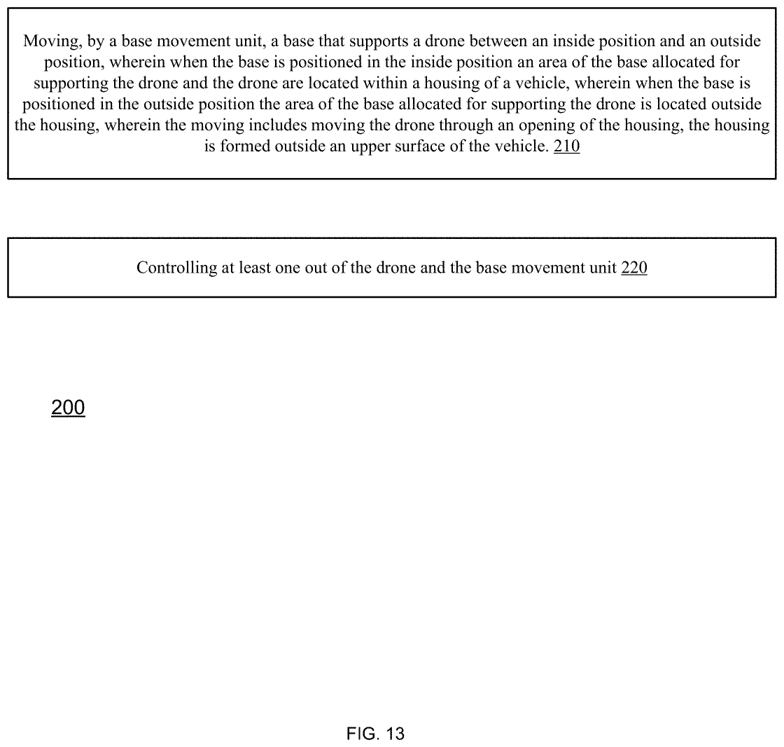

### DETAILED DESCRIPTION OF THE DRAWINGS

A system is provided. The system may be used for height spreading of observation, signaling equipment, antennas, transmission relay station, anti-terrorist surveillance, and the like. The system may be a light, compact and portable and may include a ground unit and an aerial unit.

Various applications can use the system, for example: observation, height photographing, a reception/transmission relay, spot marking (by a projector or laser), antennas etc.

The aerial unit may be a drone that is equipped with a payload that may include one or more sensors that can be used for observation, signaling equipment, antennas, transmission relay station, anti-terrorist surveillance, and the like. Non-limiting examples of the ariel unit are provided in U.S. Pat. Nos. 8,590,829, 9,056,687, 895,919 and 9,260,202.

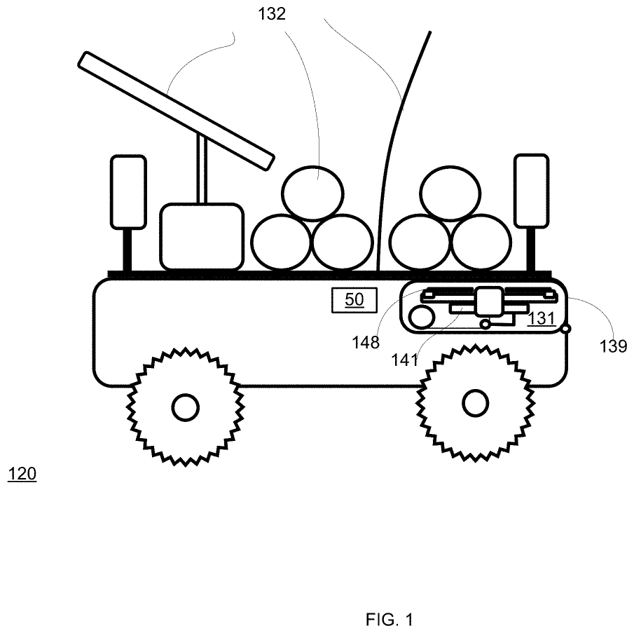

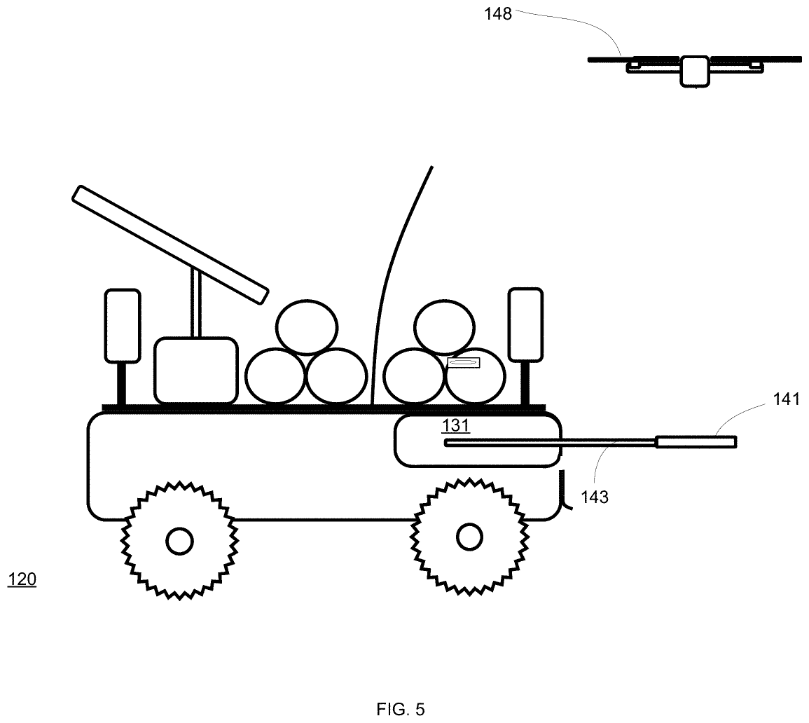

The drone may be tethered (see FIGS. 1-3) or untethered (see FIG. 5). There may be provided one or more drones.

The aerial unit may be self-controller and/or controlled by a ground unit that is associated with the vehicle. The ariel unit may be mechanically coupled to the vehicle or to the ground unit or to any other mechanical element that is mechanically coupled to the vehicle by a connecting element such as a flexible cable. The flexible cable may be maintained in a tensed status while the aerial unit is in the air.

Alternatively—the ariel unit may not be mechanically coupled to the vehicle or to the ground unit or to any other mechanical element that is mechanically coupled to the vehicle by a connecting element such as a flexible cable

In order not to “consume” any area of the upper surface of the vehicle—the aerial unit and related equipment (such as the cable, mechanism for moving the aerial unit while grounded, mechanism for controlling and/or pulling the cable)—may be located within a housing (or space) that is not located above the upper surface, and/or does not have an opening for releasing the drone through the upper surface.

If, for example, the upper part of the vehicle is loaded with payload then the aerial unit and related equipment may be positioned within a space or housing below the payload and then emerge from the side of the vehicle.

The housing (or space) may be located below the payload, above the payload or at any other location that does not consume (or substantially does not consume) area of the upper surface of the vehicle.

When the aerial unit is activated it is moved out of the housing and then may elevate itself to be positioned above the payload.

When the services of the aerial unit are not required—the aerial unit may be sent back to its close position within the housing.

The housing may be sealed from the environment or may be at least partially open.

The aerial unit may be moved between the open state (outside position) to the closed state (inside position) by any movement—linear, non-linear, movement confined to a certain plane, a three dimensional movement that extends from one plane.

Any combination of mechanical elements can be sued to move the aerial unit-including one or more joints, a telescopic rod, and the like.

FIGS. 1-3 and 5 illustrate examples of systems that are installed on vehicle 120. FIGS. 1-3 illustrate a tethered drone while FIG. 5 illustrates an untethered drone.

FIG. 1-3 illustrate different steps in a deployment of the aerial unit.

In FIG. 1 the aerial unit 148 is within a housing 131 formed within a vehicle 120. The vehicle 120 is equipped with additional payload 132. The housing 131 is below the additional payload. The housing 131 has an opening 139. The opening 139 may be covered, and/or exposed, and/or at least partially covered by one or more covering elements (not shown).

In FIG. 1 the base 141 is positioned at an inside position. In the inside position an area of the base allocated for supporting the aerial unit is located within the housing. The area of the base may be the entire base, or only a part of the base. The area of the base allocated for supporting the aerial unit may include, at least, the area on which the wheels of the ariel unit are positioned, the are that is positioned immediately under the aerial unit when the aerial unit is positioned on the base, and the like. The shape and/or the size of the area of the base allocated for supporting the aerial unit may differ to the shape and/or the size of the projection (for example a normal projection) of the drone on the base.

FIG. 1 illustrates a controller 50 for controlling at least one out of the movement of the aerial unit in and out of the housing 131, the take off of the aerial unit, the landing of the aerial unit, and the like.

The vehicle may include at least one sensor for sending the drone while flying, and/or during takeoff and/or during landing and/or when positioned in any position, and/or when moved between the inside position and the outside position. The sensor may belong to the vehicle. A sensor may be included in the aerial unit.

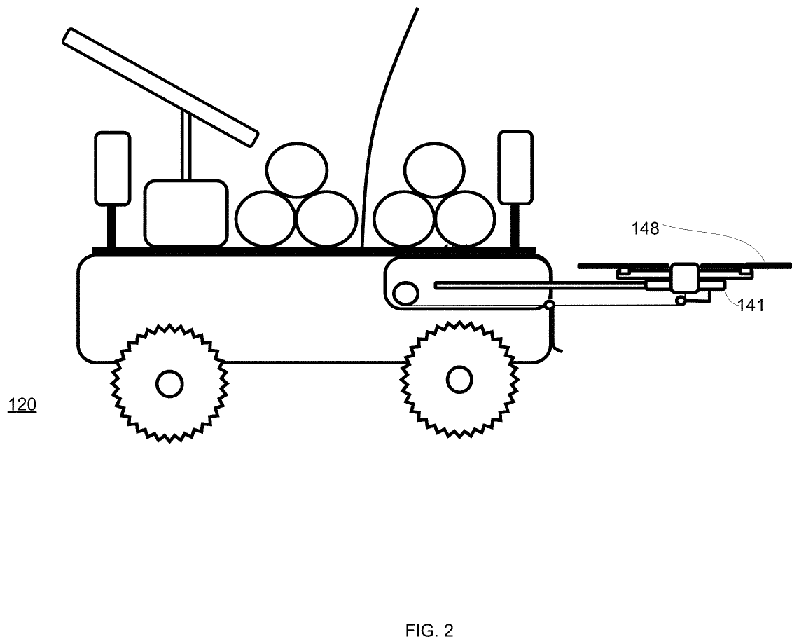

FIG. 2 illustrates an intermediate phase of the deployment process—the aerial unit 148 exited the housing 131 but is still located on the base 141. The base 141 may have any shape or size. The base may be larger than the drone, may smaller than the drone, and the like.

In FIG. 2 the base 141 is positioned in the outside position. When positioned at the outside position—the area of the base allocated for supporting the drone is located outside the housing.

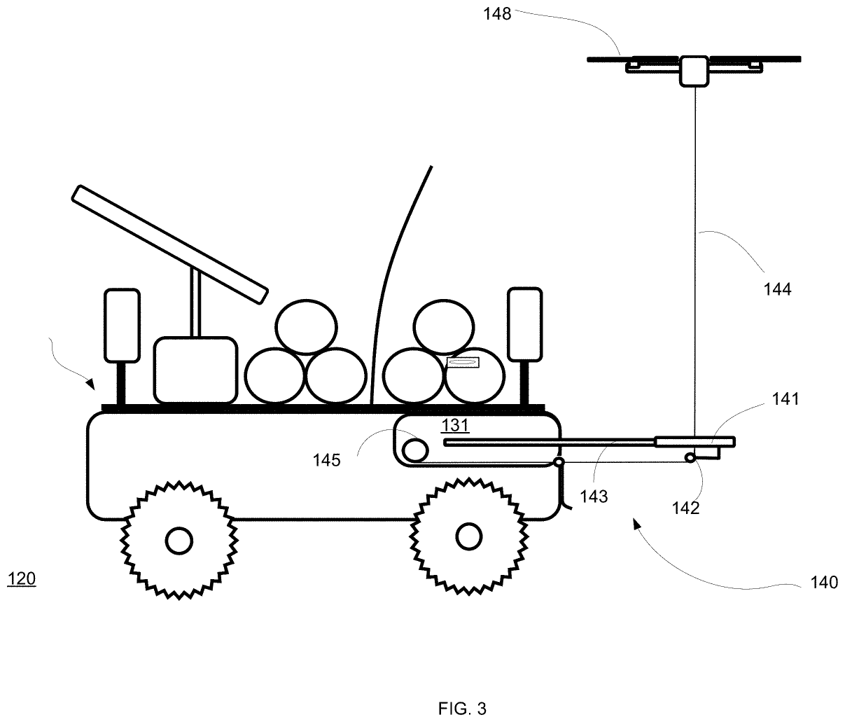

FIG. 3 illustrates the completion of the deployment—and aerial unit 148 is hovering above the base while connected to the flexible cable 144.

FIG. 3 illustrates the aerial unit and related equipment as including base 141 (on which the aerial unit lands), gear 142, telescopic arm 143 (for moving the base 141 in and out of the housing 131), flexible cable 144, pully 145 for controlling the flexible cable, and aerial unit 148. The flexible cable 144 may supply power and/or commands to the aerial unit. The telescopic arm is merely an example of a base movement unit. The base movement unit may include any element that may assist in moving the base between the inside position and the outside portion. The base movement unit may perform any movement or any combination of movements including linear movement, non-linear movement, elevation, rotation, and the like.

FIG. 3 also illustrates that an apparatus 140 may be provided. The apparatus 140 does not include the vehicle and may be adapted to be attached to or integrated with the vehicle. The apparatus 140 include the base 141 and the base movement unit. The apparatus may include the drone.

The apparatus may include the housing. Alternatively—the apparatus may be shaped and size to be located within the housing.

The steps of FIGS. 1-3 may be reversed when the aerial unit is returned to its inside position.

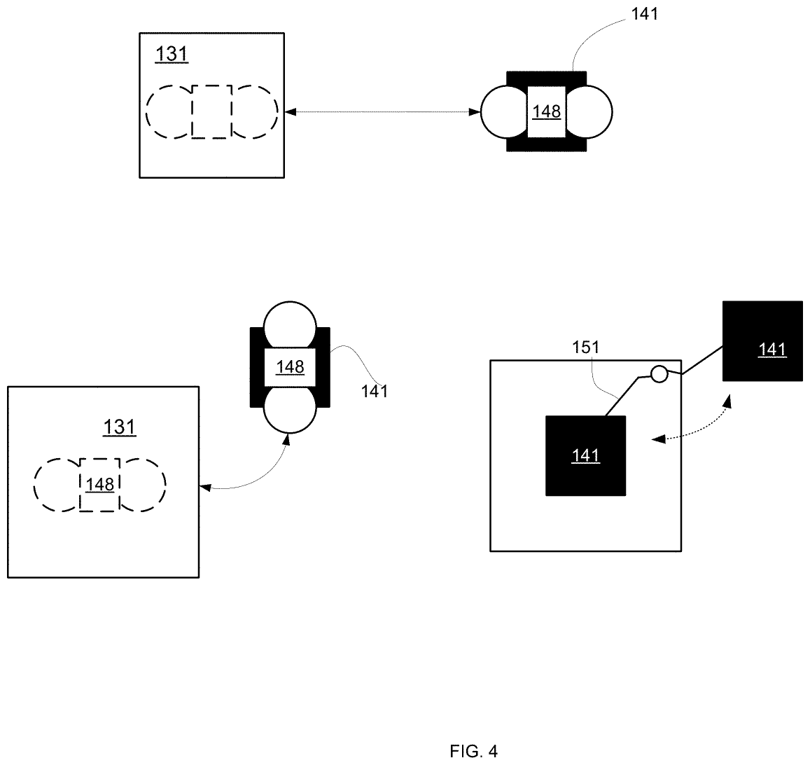

FIG. 4 illustrates various example of a movement of an aerial unit between close and open position.

The upper part of FIG. 4 illustrates a linear motion in and out the housing 131. The upper part shows that the ariel unit 148 is supported by base 141. The aerial unit is moved by moving the base 131 in and out of the housing.

The lower part of FIG. 4 illustrates a rotational motion in and out the housing 131. The base 141 is moved in a rotational manner by robotic arm 151 that may rotate the base 141 between an internal position to an external position. The robotic arm may perform any additional movements.

FIG. 5 illustrates the completion of the deployment—and aerial unit 148 is hovering above the base without being connected to the flexible cable. The base 141 is located at the outside position—away from housing 131- and supported by telescopic arm 143.

The vehicle may be any type of vehicle.

The housing may be used to store multiple aerial units. The multiple aerial units may exit the housing from one or multiple directions and/or openings.

When the housing stores multiple drones, then the multiple drones may exit through the same opening (at the same time or at different points in time) of the housing. The housing may include multiple openings for different drones and/or different openings for drones that just landed and for drones that are about to take off.

The vehicle may include multiple housings for storing a multiple drones. A housing may be allocated for storing one or more drones.

The vehicle may include one or more housings that one or more openings. When there are multiple openings then an opening may differ from another opening by at least one out of shape, size, location and orientation. Additionally or alternatively, one opening may be of the same shape and/or size and/or orientation as another opening.

The vehicle may include multiple bases and/or multiple a base movement unit. Abase may service one or more drones.

A drone may use one or more different housings. For example—a drone may be moved from one base to another and/or may be moved through one opening or another based on one or more parameters. For example—openings may be located at bot sides of the vehicle and the drone may exit through an opening that is more protected and/or is more vacant than the other side. If, for example, one side of a drone is very close to an obstacle (rock, tree, another vehicle)—then is may be beneficial to release the drone from the other side of the vehicle. If, for example, one side of the vehicle faces a sensor (for example a radar, a thermal sensor, an acoustic sensor) and the sensed footprint of the drone when exiting the vehicle exceeds the sensed footprint of the closed opening—then the drone may exit through the other side of the vehicle.

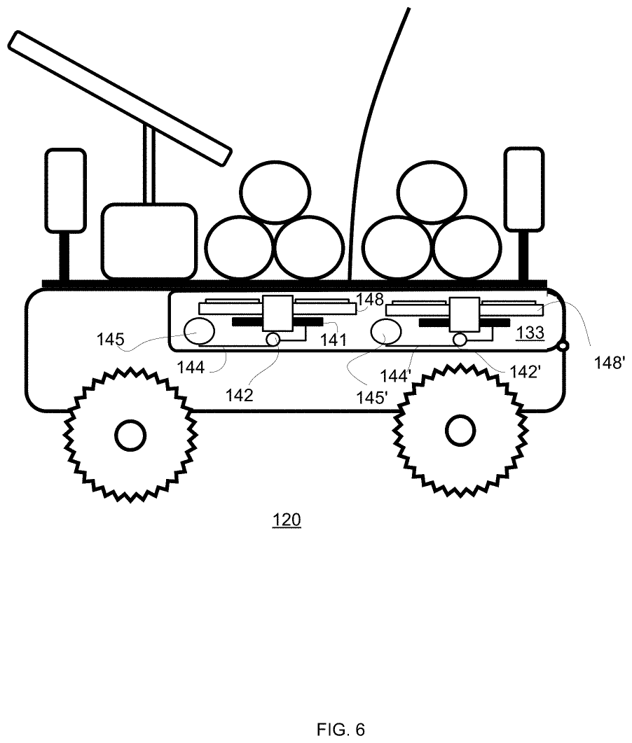

FIGS. 6-9 illustrates examples of a vehicle 120 that include one or more housing for storing aerial unit 148 and additional aerial unit 148′. More than two aerial units may be stored in the vehicle—in one or more housings.

In FIG. 6 aerial units 148 and 148′ are stored in housing 133. The housing 133 also stores (a) base 141, gear 142, flexible cable 144, and pully 145 that are associated with aerial unit 148, and (b) base 141′, gear 142′, flexible cable 144′, and pully 145′ that are associated with additional aerial unit 148′.

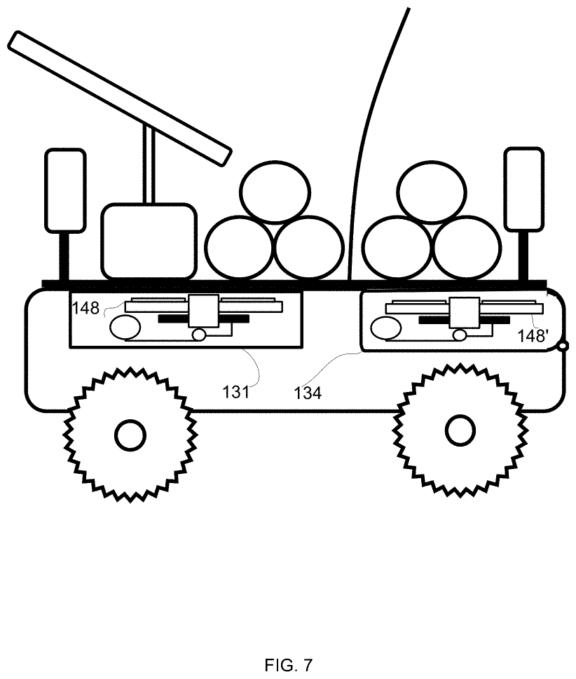

In FIG. 7 aerial unit 148 is stored in housing 131 while additional aerial unit 148′ is are stored in additional housing 134. There may be any relationship between the locations and/or shape and/or size of any housing within the vehicle.

In FIG. 7 the housing 131 and the additional housing 134 are positioned side by side—at the same height and at the same side of the vehicle.

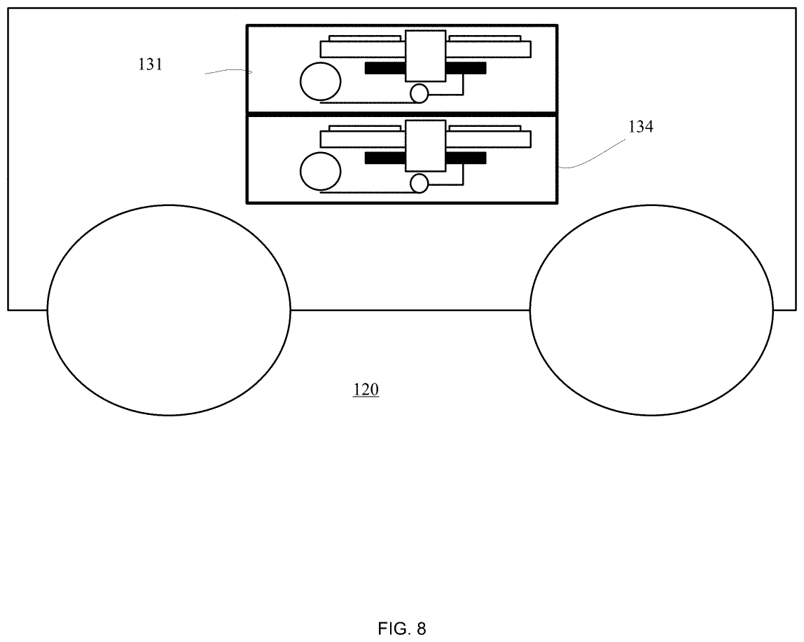

In FIG. 8 the housing 131 and the additional housing 134 are positioned at different heights and at the same side of the vehicle.

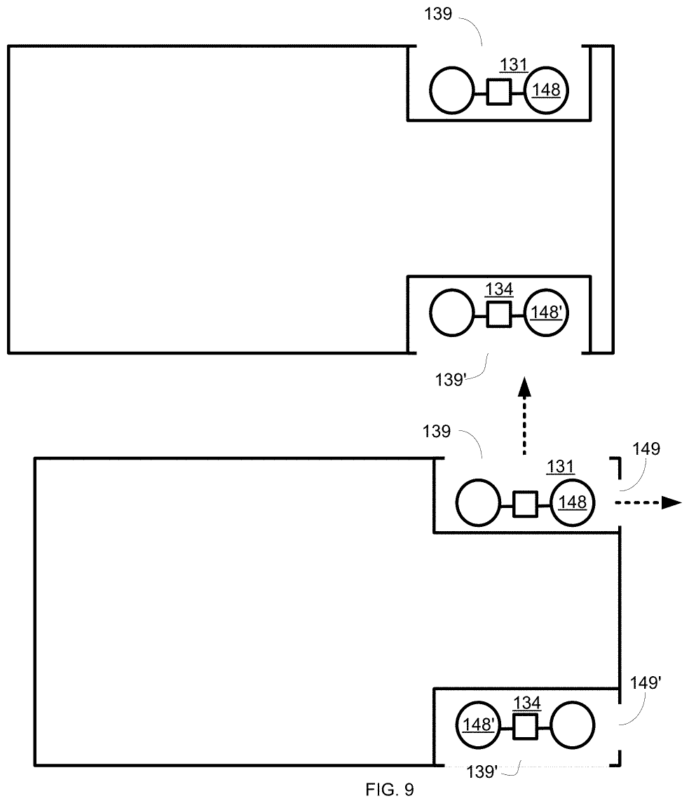

FIG. 9 illustrates two examples of a vehicle—in both cases the housing 131 and the additional housing 134 are positioned at opposite sides of the vehicle and have openings 139 and 139′ respectively that face the opposite sides of the vehicle.

The lower part of FIG. 9 illustrates an example in which each of the housing 131 and the additional housing 134 have additional openings 149 and 149′ positioned to the rear of vehicle 120. Any of the aerial unit may exit via any of the openings of its housing.

The selection may be based on the location of the vehicle, especially obstacles located near the side and/or rear part of the vehicle, on the status of the housing and/or opening—maybe an opening was damaged and/or the base movement unit is damaged or jammed and cannot move the aerial unit via one of the openings, and the like.

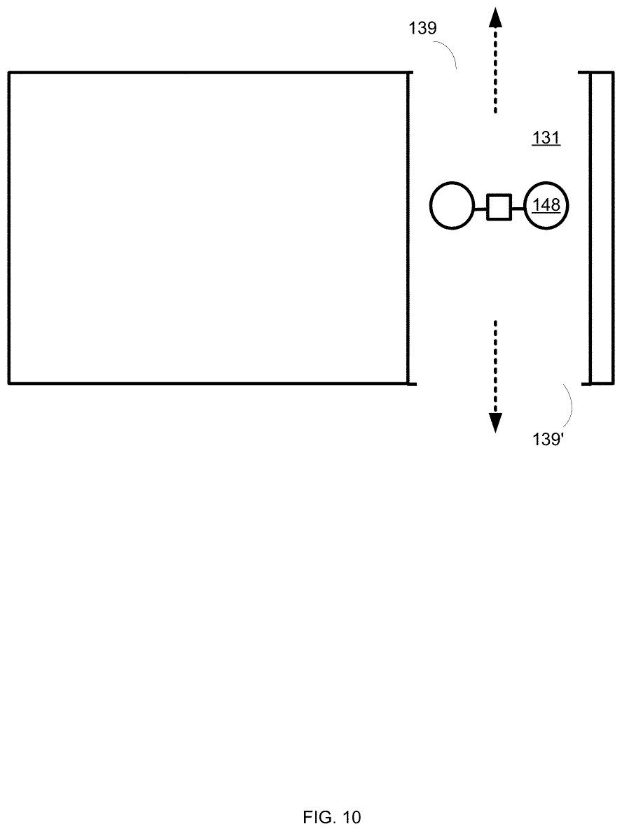

FIG. 10 illustrates a housing 131 that has openings 139 and 139′ at two opposite sides of the vehicle—and the aerial unit can be conveyed via any one of the openings. For example—a cover 151 may move about an axis such as the horizontal axis positioned at the bottom of the opening 139. Yet for another example—the cover 151 may be flexible or include many parts that enable the cover to move inside the housing 131 in any movement. Yet for a further example—the cover may include two parts 153 and 154 that may move in any manner and close and open the opening 139.

The vehicle can be a modified (the modification is illustrated in the current application) unmanned equipment conveying vehicle such as a modified squad multipurpose equipment transport vehicle, a modified Grizzly unmanned vehicle of Howe & Howe, a modified Land Systems' Multi-Utility Tactical Transport of General Dynamics, a modified six-wheel drive Global Hunter WOLF of HDT, a modified Wheeled Offload Logistics Follower, and the like.

The size of the vehicle may be of the same magnitude as the sizes of one out of the Grizzly unmanned vehicle, the Land Systems' Multi-Utility Tactical Transport, the six-wheel drive Global Hunter WOLF, or the Wheeled Offload Logistics Follower.

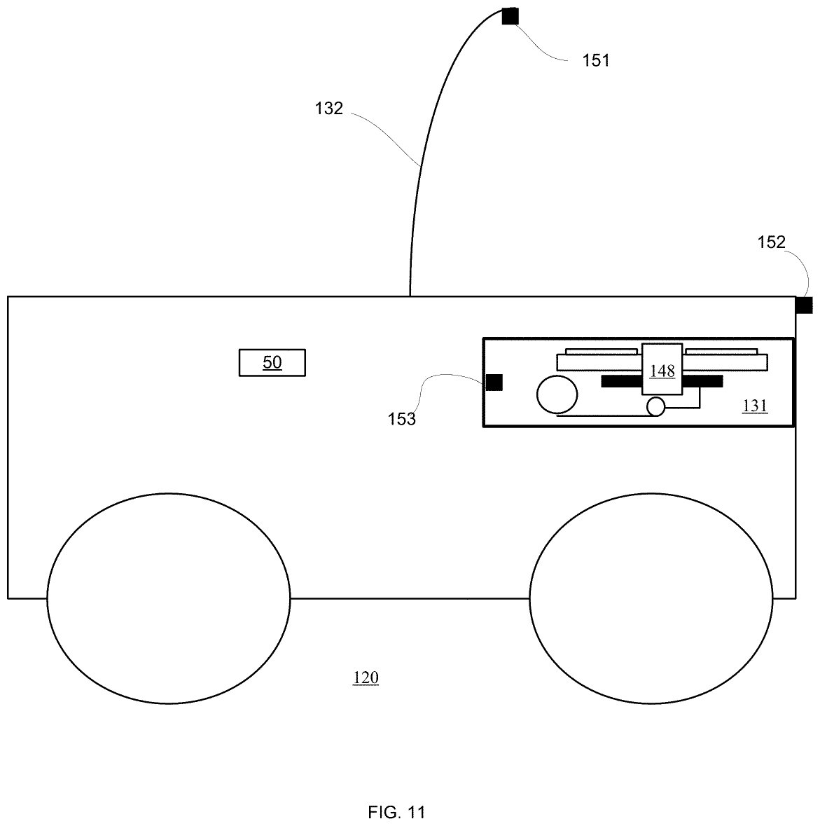

FIG. 11 illustrates vehicle 120 and various examples of sensors for monitoring at least one of the drone 148 and the deployment of the base in and out of the housing 131—in-housing sensor 153, side sensor 152 connected to the side of the vehicle, and upper sensor 151 located above the upper surface—and may be connected to the vehicle or to the payload 132.

The one or more sensors may sent wirelessly or in a wired manner sensed information to controller 50 or to any intermediate communication unit.

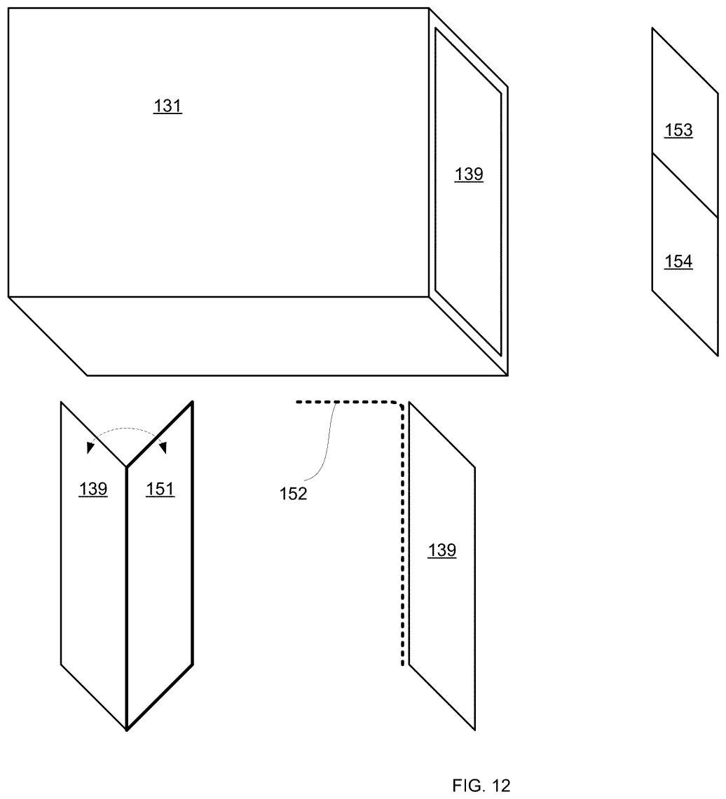

FIG. 12 illustrates housing 131, opening 139 and various examples for covers—cover 151 that rotates about an axis, a cover 152 that slides into the housing 131, two covers 153 and 154 that may move away from each other, and any other cover—sealed or unsealed, perforated or not, sliding or moving in the housing, outside the housing, and the like.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive.

Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Any reference to the term “comprising” should be applied mutatis mutandis to “consisting essentially of” and/or to “consisting”.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

We claim:

1. A vehicle comprising:
an upper surface;
a housing configured to store a drone, the housing having an opening that is formed outside the upper surface;
a base that is configured to provide a landing spot to the drone when the base is positioned at least in part outside the housing, and to support the drone when the drone is positioned within the housing; and
a base movement unit for moving the base through the opening and between an inside position and an outside position, wherein when the base is positioned in the inside position an area of the base allocated for supporting the drone is located within the housing, wherein when the base is positioned in the outside position the area of the base allocated for supporting the drone is located outside the housing.

2. The vehicle according to claim 1 wherein the opening is a sealed opening.

3. The vehicle according to claim 1 wherein the opening faces a side of the vehicle.

4. The vehicle according to claim 1 wherein the opening is formed below the upper surface.

5. The vehicle according to claim 4 wherein the opening does not face the upper surface.

6. The vehicle according to claim 1 wherein the drone is a tethered drone that is mechanically coupled, by one or more mechanical coupling elements to the base during a flight of the drone.

7. The vehicle according to claim 6 wherein the housing is configured to store the one or more mechanical coupling elements.

8. The vehicle according to claim 6 wherein the one or more mechanical coupling elements comprise a flexible cable that is mechanically coupled to the drone, a pully for controlling an effective length of the flexible cable, and a gear.

9. The vehicle according to claim 1 wherein the drone is an untethered drone.

10. The vehicle according to claim 1 wherein the base movement unit is configured to move the base between the inside position and the outside position by performing a linear movement.

11. The vehicle according to claim 1 wherein the base movement unit is configured to move the base between the inside position and the outside position by performing a rotational movement.

12. The vehicle according to claim 1 wherein the housing is positioned below the upper surface, wherein the upper surface is a payload support upper surface.

13. The vehicle according to claim 1 wherein the drone is a first drone, the base is a first base, the base movement unit is a first base movement unit, the housing is a first housing, wherein the vehicle comprises at least the first base, at least the first housing, at least the first base, and the least one base movement unit.

14. The vehicle according to claim 13 wherein the at least the first housing is configured to store multiple drones, the multiple drones comprise at least the first drone.

15. The vehicle according to claim 14 wherein the at least one base comprises multiple bases, one base for each of the multiple drones.

16. The vehicle according to claim 14 wherein the at least one base comprises multiple bases, one base for two or more drones of the multiple drones.

17. The vehicle according to claim 1 comprising a controller for controlling a flight of the drone.

18. The vehicle according to claim 1 wherein the housing has a width and length that does not exceed one and a half meters.

19. A method for operating a drone, the method comprises: moving, by a base movement unit, a base that supports a drone between an inside position and an outside position, wherein when the base is positioned in the inside position an area of the base allocated for supporting the drone and the drone are located within a housing of a vehicle, wherein when the base is positioned in the outside position the area of the base allocated for supporting the drone is located outside the housing, wherein the moving comprises moving the drone through an opening of the housing, the housing is formed outside an upper surface of the vehicle.

20. The method according to claim 19 comprising controlling a landing of the drone on the base.

21. The method according to claim 19 comprising monitoring a landing of the drone on the base.

22. The method according to claim 19 wherein the opening is a sealed opening.

23. The method according to claim 19 wherein the opening faces a side of the vehicle.

24. The method according to claim 19 wherein the opening is formed below the upper surface.

25. The method according to claim 24 wherein the opening does not face the upper surface.

26. The method according to claim 19 wherein the drone is a tethered drone that is mechanically coupled, by one or more mechanical coupling elements to the base during a flight of the drone.

27. The method according to claim 26 comprising storing, by the housing, the one or more mechanical coupling elements.

28. The method according to claim 26 wherein the one or more mechanical coupling elements comprise a flexible cable that is mechanically coupled to the drone, a pully for controlling an effective length of the flexible cable, and a gear.

29. The method according to claim 19 wherein the drone is an untethered drone.

30. The method according to claim 19 wherein the moving comprises performing a linear movement.

31. The method according to claim 19 wherein the moving comprises performing a rotational movement.

32. The method according to claim 19 wherein the housing is positioned below the upper surface, wherein the upper surface is a payload support upper surface.

33. The method according to claim 19 wherein the drone is a first drone, the base is a first base, the base movement unit is a first base movement unit, the housing is a first housing, wherein the vehicle comprises at least the first base, at least the first housing, at least the first base, and the least one base movement unit.

34. The method according to claim 33 comprising storing, by the at least first housing, multiple drones, the multiple drones comprise at least the first drone.

35. The method according to claim 34 wherein the at least one base comprises multiple bases, one base for each of the multiple drones.

36. The method according to claim 34 wherein the at least one base comprises multiple bases, one base for two or more drones of the multiple drones.

37. The method according to claim 19 wherein the housing has a width and length that does not exceed one and a half meters.

38. An apparatus comprising:
a base that is configured to provide a landing spot to a drone when the base is positioned at least in part outside a housing of a vehicle, and to support the drone when the drone may be positioned within the housing; and
a base movement unit for moving the base through an opening of the housing and between an inside position and an outside position, wherein when the base is positioned in the inside position an area of the base allocated for supporting the drone may be located within the housing, wherein when the base may be positioned in the outside position the area of the base allocated for supporting the drone may be located outside the housing.

39. The apparatus according to claim 38 comprising the housing.

40. The apparatus according to claim 38 comprising the drone.
